(19) United States
(12) Patent Application Publication
(10) Pub. No.: US 2026/0039021 A1
(43) Pub. Date: Feb. 5, 2026

(54) DIELECTRTIC RESONATOR, DIELECTRIC RESONATOR ARRAY STRUCTURE, AND ANTENNA STRUCTURE

(71) Applicant: WISTRON NEWEB CORPORATION, HSINCHU (TW)

(72) Inventors: CHIN-HSIEN WU, HSINCHU (TW); WEI-JIN CHEN, HSINCHU (TW); Nien-Tzu Chung, HSINCHU (TW); TSUN-CHE HUANG, HSINCHU (TW)

(21) Appl. No.: 19/007,700

(22) Filed: Jan. 2, 2025

(30) Foreign Application Priority Data
Aug. 2, 2024 (TW) 113128869

(51) Int. Cl. H01Q 9/04; H01Q 5/35; H01Q 21/06

(52) U.S. Cl. CPC H01Q 9/0492; H01Q 5/35; H01Q 21/061

(57) ABSTRACT

A dielectric resonator, a dielectric resonator array structure, and an antenna structure are provided. The dielectric resonator includes a resonator body and a transmission layer that are integrally formed and respectively with a plurality of grooves and a plurality of through holes. Each through hole and its corresponding groove jointly form a hollow structure. The dielectric resonator array structure includes a plurality of dielectric resonators arranged in different directions. The antenna structure includes a circuit board, a first feed line, a second feed line, a ground layer with a cross-shaped slot, and a dielectric resonator. The first feed line and the second feed line are embedded in the circuit board. The ground layer is disposed on a surface of the circuit board. The first feed line and the second feed line are separated from and coupled to the cross-shaped slot, to excite the dielectric resonator.

### CROSS-REFERENCE TO RELATED PATENT APPLICATION

This application claims the benefit of priority to Taiwan Patent Application No. 113128869, filed on Aug. 2, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a dielectric resonator, a dielectric resonator array structure, and an antenna structure, and more particularly, to a dielectric resonator, a dielectric resonator array structure, and an antenna structure that increases bandwidth and reduces manufacturing costs.

### BACKGROUND OF THE DISCLOSURE

With the development of communication technology, low-orbit satellite network systems play an increasingly important role in next-generation mobile communication networks. The architecture of low-orbit satellite network systems includes Low-Earth-Orbit (LEO) satellites and user terminals (UT) that access various LEO satellites. User terminals' transceivers can be configured to transmit and receive signals at radio frequencies or millimeter-wave frequencies. The transceivers may include antenna arrays, which can contain one or more antennas for transmitting and receiving omnidirectional or directional antenna beams.

Generally, antenna arrays used in low-orbit satellite communication systems consist of hundreds or even thousands of antenna units, which are relatively expensive and still have room for improvement in performance (e.g., bandwidth of operating frequency).

### SUMMARY OF THE DISCLOSURE

In one aspect, the present disclosure provides a dielectric resonator, which includes a resonator body and a transmission layer. The resonator body has a plurality of grooves that are evenly and symmetrically distributed on a side surface of the resonator body. The resonator body is connected to the transmission layer, and the resonator body and the transmission layer are integrally formed. The transmission layer has a plurality of through holes respectively corresponding to and communicating with the plurality of grooves, and each through hole and the corresponding groove jointly form a hollow structure.

In another aspect, the present disclosure provides a dielectric resonator array structure, which includes a plurality of dielectric resonators. The dielectric resonators are arranged along a first direction and a second direction, where the first direction is perpendicular to the second direction. Each dielectric resonator includes a resonator body and a transmission layer. The resonator body is connected to the transmission layer, and the resonator body and the transmission layer are integrally formed. The transmission layer is a cuboid structure with a plurality of corners, and adjacent transmission layers are connected to each other through at least one of the corners.

In yet another aspect, the present disclosure provides an antenna structure, which includes a circuit board, a first feed line, a second feed line, a ground layer, and a dielectric resonator. The circuit board has an upper surface. The first feed line and the second feed line are embedded in the circuit board. The ground layer is disposed on the upper surface and has a cross-shaped slot. The dielectric resonator includes a resonator body and a transmission layer that are integrally formed. The resonator body is connected to the transmission layer, and the transmission layer is disposed on the ground layer. The projection area of the dielectric resonator on the ground layer overlaps the cross-shaped slot. The first feed line and the second feed line are separated from and coupled to the cross-shaped slot to excite the dielectric resonator.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a dielectric resonator according to an embodiment of the present disclosure.

FIG. 2 is another schematic diagram of the dielectric resonator according to an embodiment of the present disclosure.

FIG. 3 is a side view schematic diagram of the dielectric resonator according to an embodiment of the present disclosure.

FIG. 4 is a schematic diagram of a dielectric resonator array structure according to an embodiment of the present disclosure.

FIG. 5 is a top view schematic diagram of the dielectric resonator array structure according to an embodiment of the present disclosure.

FIG. 6 is an exploded view schematic diagram of an antenna structure according to an embodiment of the present disclosure.

FIG. 7 is a side view schematic diagram of a circuit board of the antenna structure according to an embodiment of the present disclosure.

FIG. 8 is a top view schematic diagram of the antenna structure according to an embodiment of the present disclosure.

FIG. 9 is a reflection loss curve diagram of the antenna structure according to an embodiment of the present disclosure.

FIG. 10 is a gain curve diagram of the antenna structure according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In addition, the term “or”, as used herein, should include any one or a combination of the associated enlisted items, as the case may be. The term “connect” in the context of the present disclosure means there is a physical connection between two elements and is directly or indirectly connected. The term “couple” in the context of the present disclosure means there is no physical connection between two separated elements, and the two elements are instead connected by their electric field energy where the electric field energy generated by the current of one element excites the electric field energy of the other element.

### EMBODIMENT

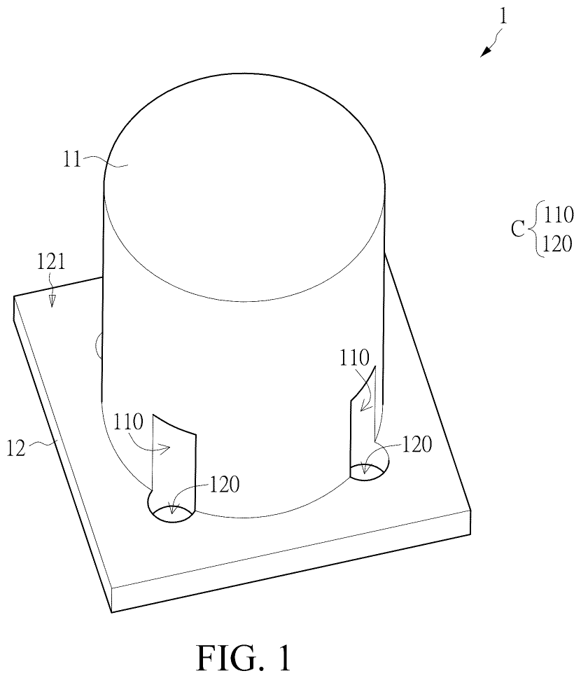

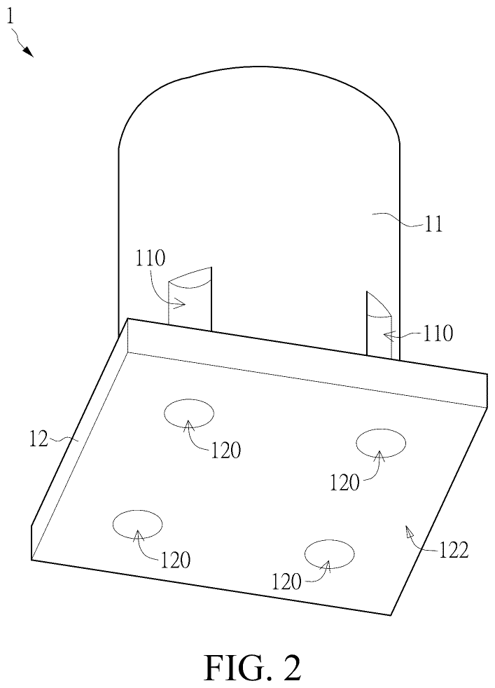

Referring to FIGS. 1 and 2, which are schematic diagrams of the dielectric resonator according to an embodiment of the present disclosure. The present disclosure provides a dielectric resonator 1, which includes a resonator body 11 and a transmission layer 12. The material of the dielectric resonator 1 can be made of low-loss and high-dielectric constant materials, but the present disclosure is not limited thereto. In the present disclosure, the resonator body 11 is connected to the transmission layer 12 to form an integrally formed structure. In the embodiment of the present disclosure, the resonator body 11 is a cylinder, and the transmission layer 12 is a cuboid structure. However, the present disclosure does not limited the shapes of the resonator body 11 and the transmission layer 12.

The resonator body 11 includes a plurality of grooves 110. The grooves 110 are formed on the side surface of the resonator body 11. Furthermore, the grooves 110 are evenly and symmetrically distributed on the side surface of the resonator body 11. The transmission layer 12 has a first surface 121 and a second surface 122, which are opposite to each other and preferably square. The resonator body 11 is connected to the first surface 121. The transmission layer 12 also includes a plurality of through holes 120, and each through hole 120 penetrates the first surface 121 and the second surface 122.

As shown in FIG. 1, the through holes 120 respectively correspond to and communicate with the grooves 110, and each through hole 120 and the corresponding groove 110 jointly form a hollow structure C. The projection areas of the grooves 110 on the first surface 121 of the transmission layer 12 respectively overlap with the through holes 120.

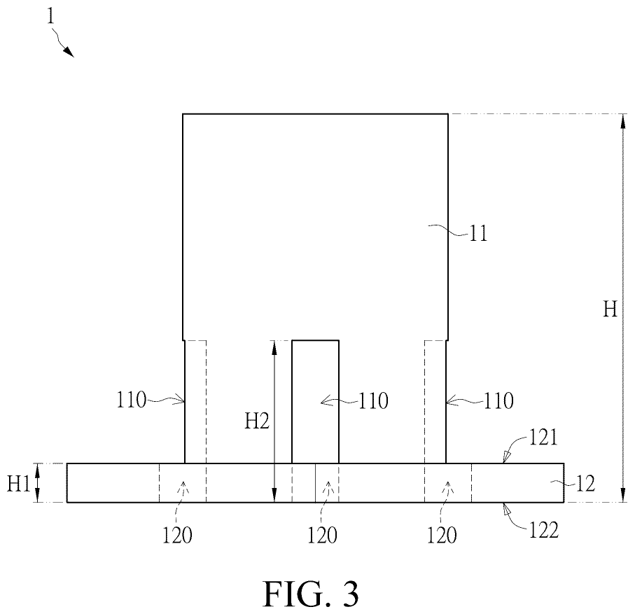

Referring to FIG. 3, which is a side view schematic diagram of the dielectric resonator according to an embodiment of the present disclosure. The first surface 121 and the second surface 122 have a predetermined distance H1 between them, which is the thickness of the transmission layer 12. The predetermined distance H1 is between 0.5 mm and 1.5 mm, preferably 1 mm. The hollow structure C (including the grooves 110 and the through holes 120) has a preset height H2, which is between 40% and 60% of the height H of the dielectric resonator 1, preferably 50%.

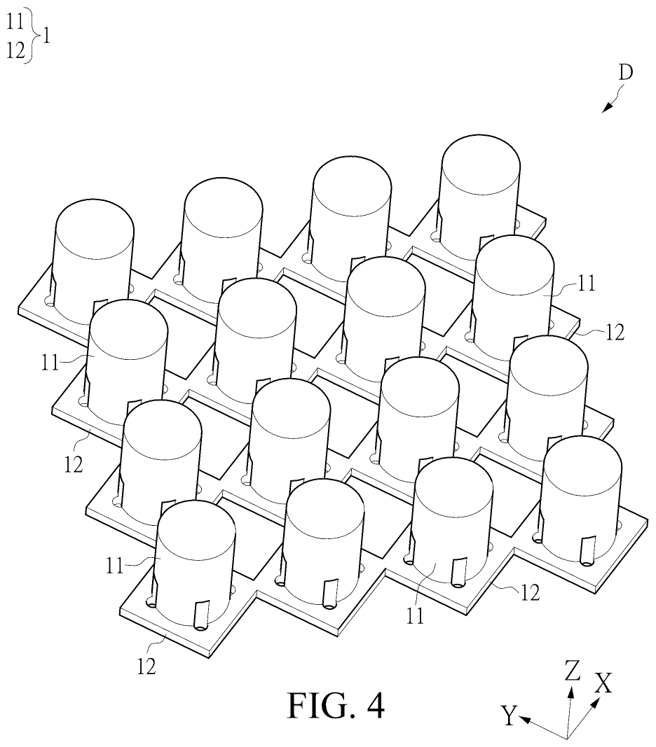

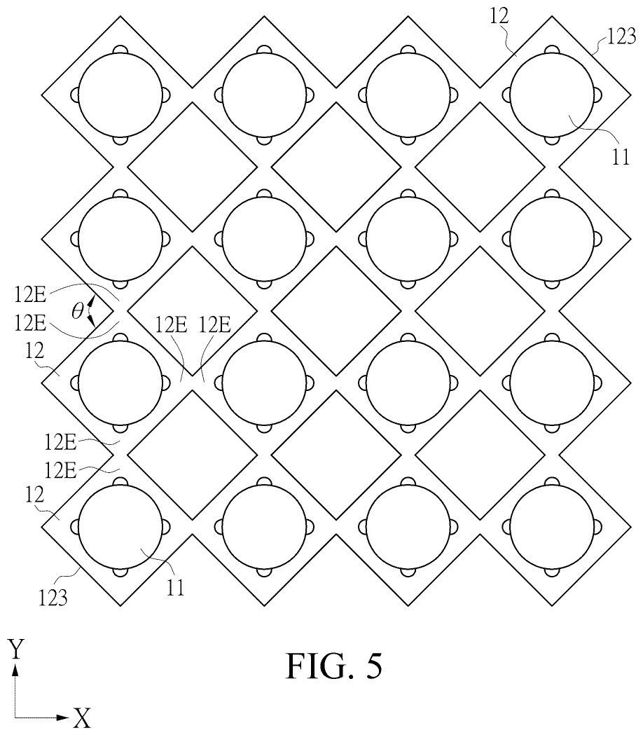

Referring to FIGS. 4 and 5, which are schematic diagrams of the dielectric resonator array structure according to an embodiment of the present disclosure. The present disclosure also provides a dielectric resonator array structure D, which is composed of a plurality of dielectric resonators 1. Specifically, the dielectric resonators 1 are arranged along a first direction (X-axis direction) and a second direction (Y-axis direction), where the first direction is perpendicular to the second direction. Furthermore, as shown in FIG. 5, each side edge 123 of the transmission layer 12 forms a 45-degree angle with the first direction or the second direction.

In the present disclosure, each transmission layer 12 is a cuboid with a plurality of corners 12E, so in the dielectric resonator array structure D, adjacent transmission layers 12 are connected to each other through the corners 12E. In other words, the present disclosure can connect multiple dielectric resonators 1 together to form a one-piece structure through the design of the transmission layer 12 (i.e., the integrally formed transmission layer 12 and resonator body 11, and the transmission layer 12 being rotated by 45 degrees), which is the dielectric resonator array structure D. This reduces the complexity of the manufacturing process and lowers manufacturing costs. Additionally, in the dielectric resonator array structure D of the present disclosure, since the transmission layer 12 is a cuboid structure, adjacent transmission layers 12 are connected through the corners 12E, forming a fixed 90-degree angle (see FIG. 5), which is easier to control during manufacturing. Conversely, if the transmission layer 12 is of another shape, such as a circle, the angle between adjacent transmission layers 12 after connection would be an arbitrary acute angle, making it difficult to control during manufacturing, increasing production difficulty and manufacturing costs.

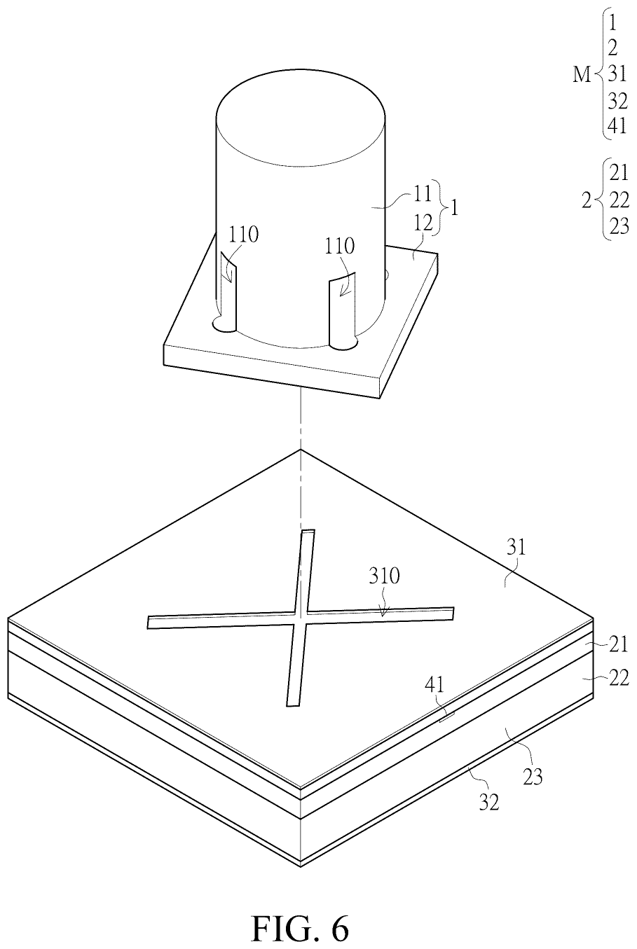

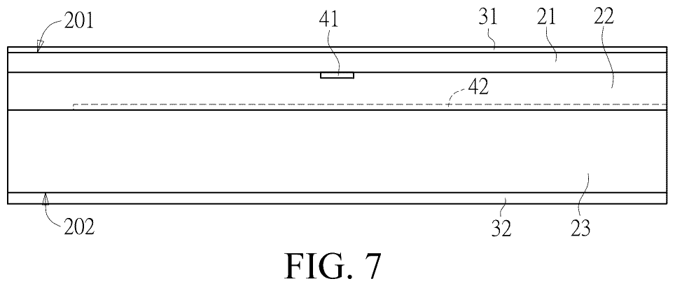

Referring to FIGS. 6 and 7, which are an exploded view schematic diagram of an antenna structure and a side view schematic diagram of the circuit board of the antenna structure according to an embodiment of the present disclosure. The antenna structure M includes a dielectric resonator 1, a circuit board 2, a plurality of feed lines, and a plurality of ground layers. It should also be noted that in practical applications, low-orbit satellite network systems operate in the form of array antennas. Array antennas are composed of multiple antenna structures M, and adjacent antenna structures M are connected to each other through the transmission layer 12 of the dielectric resonator 1. In other words, in the array antenna of the present disclosure, the dielectric resonators 1 of multiple antenna structures M form the dielectric resonator array structure D.

The plurality of ground layers include a first ground layer 31 and a second ground layer 32, which are respectively disposed on the upper surface 201 and the lower surface 202 of the circuit board 2. The plurality of feed lines include a first feed line 41 and a second feed line 42, which are embedded in the circuit board 2. For example, the feed lines can be made of microstrip lines, and the ground layers can be made of metal materials, but the present disclosure is not limited thereto.

The first ground layer 31 has a cross-shaped slot 310. The transmission layer 12 of the dielectric resonator 1 is disposed on the first ground layer 31. The first feed line 41 and the second feed line 42 are separated from the cross-shaped slot 310 and do not contact the cross-shaped slot 310. Furthermore, the projection area of the dielectric resonator 1 vertically projected on the first ground layer 31 overlaps with the cross-shaped slot 310. Thus, the first feed line 41 and the second feed line 42 can be coupled with the cross-shaped slot 310 to excite the dielectric resonator 1 to generate at least one operating frequency. For example, the operating frequency is about 14 GHz when transmitting signals (Tx signals) and about 12-13 GHz when receiving signals (Rx signals).

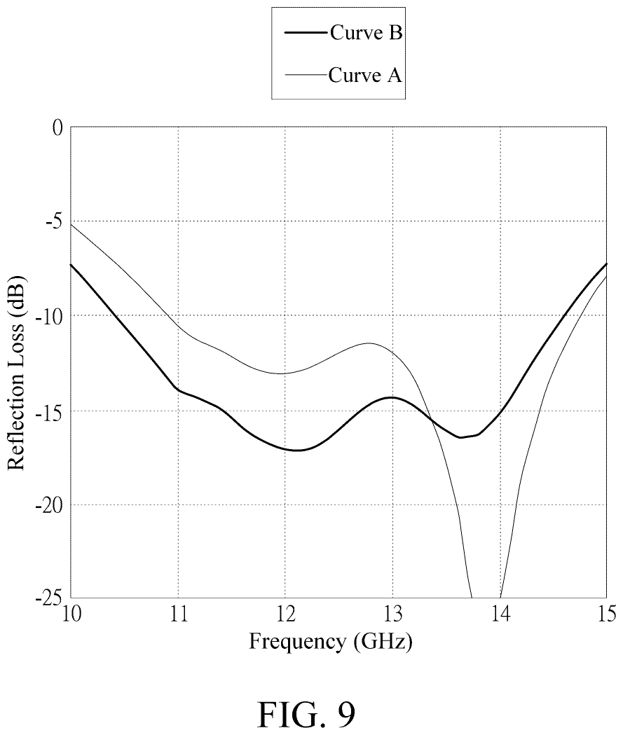

Referring to FIG. 6, the antenna structure M of the present disclosure can determine the generated operating frequency through the parameters (such as dielectric constant, radius, and height) of the cylindrical resonator body 11 of the dielectric resonator 1, while the transmission layer 12 can further improve matching and increase the bandwidth of the antenna structure M. Referring to FIG. 9, which is a reflection loss curve diagram of the antenna structure according to an embodiment of the present disclosure. In FIG. 9, curve A represents the conventional dielectric resonator without the transmission layer structure, and curve B represents the dielectric resonator 1 of the present disclosure with the transmission layer 12. Comparing the two curves, it is clear that under the same reflection loss (generally based on −10 dB), the bandwidth range covered by curve B is significantly larger than that covered by curve A.

Additionally, as shown in FIG. 3, the aforementioned description has mentioned that the thickness of the transmission layer 12 (i.e., the predetermined distance H1) is between 0.5 mm and 1.5 mm. Furthermore, when the thickness of the transmission layer 12 increases (predetermined distance H1 increases), the operating frequency generated by the antenna structure M shifts to a lower frequency; when the thickness of the transmission layer 12 decreases (predetermined distance H1 decreases), the operating frequency generated by the antenna structure M shifts to a higher frequency. Moreover, regardless of whether the thickness of the transmission layer 12 increases or decreases, it may lead to a reduction in the bandwidth generated by the antenna structure M.

Additionally, it is worth mentioning that for the array antenna of the present disclosure, the distance between adjacent resonator bodies 11 of the dielectric resonators 1 in the dielectric resonator array structure D is approximately equal to half the wavelength of the operating frequency.

Furthermore, whether it is the antenna structure M or the array antenna composed of the dielectric resonator array structure D, the height design of the hollow structure C (including the grooves 110 and the through holes 120) (i.e., the preset height H2 is between 40% and 60% of the height H of the dielectric resonator 1) can further enhance the gain of the antenna structure M (or array antenna), and the structural design of the hollow structure C is also conducive to the manufacturing of the dielectric resonator 1 by demolding.

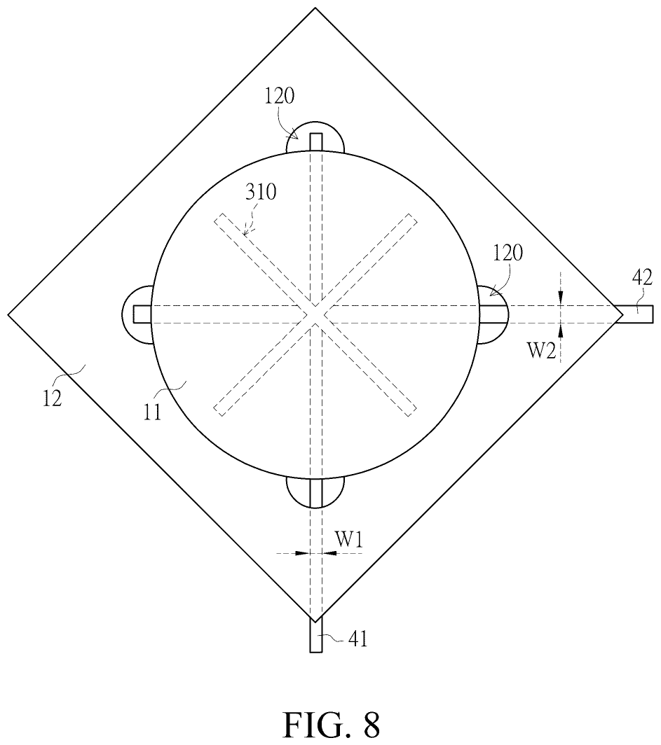

Additionally, referring to FIG. 1 and FIG. 8, in the dielectric resonator 1, the number of hollow structures C is preferably at least four or a multiple of four. Specifically, the number of hollow structures C must be such that they are evenly and symmetrically distributed in different directions. For example, as shown in FIG. 1 and FIG. 8, the four hollow structures C are evenly and symmetrically distributed on the side surface of the dielectric resonator 1; in other words, the four hollow structures C can be evenly and symmetrically distributed in two directions (X-axis direction and Y-axis direction).

As shown in FIG. 7 and FIG. 8, in the present disclosure, the circuit board 2 is a multilayer structure, including the first layer 21, the second layer 22, and the third layer 23 from top to bottom. The first feed line 41 and the second feed line 42 are respectively located in different layers within the circuit board 2. For example, the first feed line 41 is embedded between the first layer 211 and the second layer 212, while the second feed line 42 is embedded between the second layer 212 and the third layer 213. In this embodiment, the first feed line 41 is located above the second feed line 42 and is closer to the first ground layer 31, so the width W1 of the first feed line 41 is smaller than the width W2 of the second feed line 42.

Furthermore, as shown in FIG. 8, the first feed line 41 and the second feed line 42 are vertically aligned with each other, and both pass through the center intersection point of the cross-shaped slot 310. By vertically aligning the first feed line 41 and the second feed line 42 and in cooperation with the configuration of the cross-shaped slot 310, the first feed line 41 and the second feed line 42 can feed signals from different directions, thereby achieving circular polarization of the antenna array.

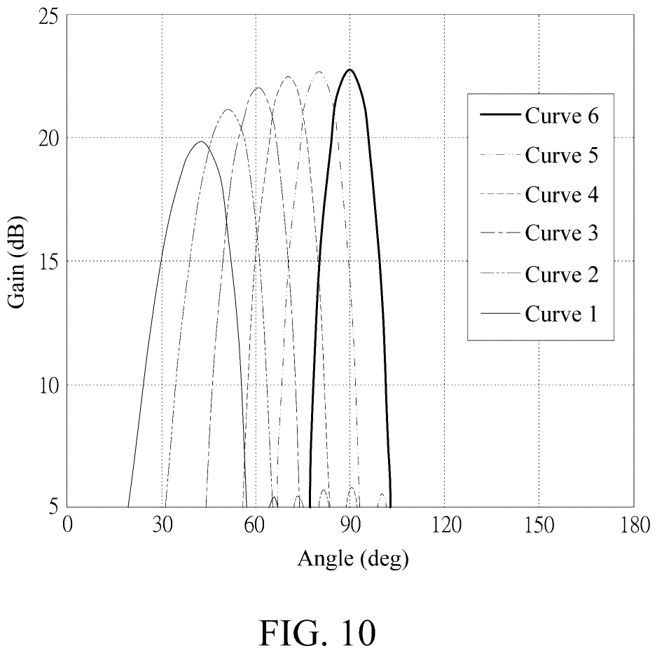

Referring to FIGS. 4 and 10, FIG. 10 is a gain curve diagram of the antenna structure according to an embodiment of the present disclosure. FIG. 10 shows the distribution of the reception (Rx) signal gain at different angles after achieving circular polarization in the antenna array. Since the resonator body 11 of the dielectric resonator 1 in the antenna structure M is cylindrical, the axial direction of the resonator body 11 can be used as the orientation of the antenna array. As shown in FIG. 4, taking the Y-axis as 0 degrees and the Z-axis as 90 degrees as the reference, curves one, two, three, four, five, and six represent the gain of the array antenna at angles of 40 degrees, 50 degrees, 60 degrees, 70 degrees, 80 degrees, and 90 degrees, respectively.

For example, the array antenna at a 40-degree angle refers to the angle between the axial direction of the resonator body 11 and the Y-axis. The peak gain at a 40-degree angle is about 19.59 dB, at a 50-degree angle is about 21.05 dB, at a 60-degree angle is about 21.97 dB, at a 70-degree angle is about 22.43 dB, at an 80-degree angle is about 22.65 dB, and at a 90-degree angle is about 22.73 dB. From FIG. 10, it can be seen that the scan loss of the array antenna in different directions is not large, about 3.1 dB. Additionally, the present disclosure only takes the reception (Rx) signal as an example, and the distribution of the transmission (Tx) signal gain is similar. In other words, the array antenna of the present disclosure can transmit and receive signals at large angles without significant signal degradation issues.

### Beneficial Effects of the Embodiment

The dielectric resonator 1, dielectric resonator array structure D, and antenna structure M provided by the present disclosure can increase the bandwidth of the antenna operating frequency through the integrally formed structure design of the transmission layer 12 and resonator body 11.

Furthermore, the antenna structure M can determine the generated operating frequency through the parameters (such as dielectric constant, radius, and height) of the cylindrical resonator body 11 of the dielectric resonator 1, while the transmission layer 12 can further improve matching and increase the bandwidth of the antenna structure M. Moreover, in the present disclosure, multiple antenna structures M can be used to form an array antenna, and adjacent antenna structures M in the array antenna can be connected to each other through the transmission layer 12 of the dielectric resonator 1 in a configuration that the transmission layers 12 are rotated by 45 degrees. Therefore, in the array antenna of the present disclosure, the dielectric resonators 1 of multiple antenna structures M form a one-piece dielectric resonator array structure D. This reduces the complexity of the manufacturing process and lowers manufacturing costs.

Moreover, regardless of whether it is the antenna structure M or the array antenna composed of the dielectric resonator array structure D, the height design of the hollow structure C (including the grooves 110 and the through holes 120) (i.e., the preset height H2 is between 40% and 60% of the height H of the dielectric resonator 1) can further enhance the gain of the antenna structure M (or array antenna).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A dielectric resonator, comprising:
a resonator body, comprising a plurality of grooves, wherein the plurality of grooves are evenly and symmetrically distributed on a side surface of the resonator body; and
a transmission layer, connected to the resonator body and comprising a plurality of through holes, wherein the resonator body and the transmission layer are integrally formed, the plurality of through holes respectively correspond to and communicate with the plurality of grooves, and each of the plurality of through holes and a corresponding one of the plurality of grooves jointly form a hollow structure.

2. The dielectric resonator as claimed in claim 1, wherein a plurality of projection areas of the plurality of grooves vertically projected onto a surface of the transmission layer respectively overlap the plurality of through holes.

3. The dielectric resonator as claimed in claim 1, wherein the resonator body is cylindrical.

4. The dielectric resonator as claimed in claim 1, wherein the transmission layer has a first surface and a second surface opposite to the first surface, the resonator body is connected to the first surface, each of the plurality of through holes penetrates the first surface and the second surface, a predetermined distance is defined between the first surface and the second surface, and the predetermined distance is between 0.5 mm and 1.5 mm.

5. The dielectric resonator as claimed in claim 1, wherein the hollow structure has a preset height, and the preset height is between 40% and 60% of a height of the dielectric resonator.

6. A dielectric resonator array structure, comprising:
a plurality of dielectric resonators, arranged along a first direction and a second direction, the first direction being perpendicular to the second direction, each of the plurality of dielectric resonators comprising:
a resonator body; and
a transmission layer, connected to the resonator body, wherein the resonator body and the transmission layer are integrally formed, and the transmission layer is a cuboid structure with a plurality of corners;
wherein two adjacent ones of the transmission layers are connected to each other through at least one of the plurality of corners.

7. The dielectric resonator array structure as claimed in claim 6, wherein the transmission layer has a first surface and a second surface opposite to the first surface, the resonator body is connected to the first surface, and a side edge of the transmission layer forms a 45-degree angle with the first direction or the second direction.

8. The dielectric resonator array structure as claimed in claim 7, wherein a predetermined distance is defined between the first surface and the second surface, and the predetermined distance is between 0.5 mm and 1.5 mm.

9. The dielectric resonator array structure as claimed in claim 7, wherein the resonator body comprises a plurality of grooves evenly and symmetrically distributed on a side surface of the resonator body, the transmission layer comprises a plurality of through holes respectively corresponding to and communicating with the plurality of grooves, each of the plurality of through holes penetrates the first surface and the second surface, and each of the plurality of through holes and a corresponding one of the plurality of grooves jointly form a hollow structure.

10. The dielectric resonator array structure as claimed in claim 9, wherein the hollow structure has a preset height, and the preset height is between 40% and 60% of a height of the dielectric resonator.

11. The dielectric resonator array structure as claimed in claim 9, wherein a plurality of projection areas of the plurality of grooves vertically projected onto on a surface of the transmission layer respectively overlap the plurality of through holes.

12. The dielectric resonator array structure as claimed in claim 6, wherein the resonator body is cylindrical.

13. An antenna structure, comprising:
a circuit board, having an upper surface;
a first feed line and a second feed line, embedded in the circuit board;
a ground layer, disposed on the upper surface of the circuit board and comprising a cross-shaped slot; and
a dielectric resonator, comprising a resonator body and a transmission layer, wherein the resonator body and the transmission layer are integrally formed, the resonator body is connected to the transmission layer, the transmission layer is disposed on the ground layer, and a projection area of the dielectric resonator on the ground layer overlaps the cross-shaped slot;
wherein the first feed line and the second feed line are separated from and coupled to the cross-shaped slot to excite the dielectric resonator.

14. The antenna structure as claimed in claim 13, wherein the transmission layer has a first surface and second surface opposite to the first surface, a predetermined distance is defined between the first surface and the second surface, and the predetermined distance is between 0.5 mm and 1.5 mm.

15. The antenna structure as claimed in claim 14, wherein the resonator body comprises a plurality of grooves evenly and symmetrically distributed on a side surface of the resonator body, the transmission layer comprises a plurality of through holes respectively correspond to and communicate with the plurality of grooves, each of the plurality of through holes penetrates the first surface and the second surface, and each of the plurality of through holes and a corresponding one of the plurality of grooves jointly form a hollow structure.

16. The antenna structure as claimed in claim 15, wherein the hollow structure has a preset height, and the preset height is between 40% and 60% of a height of the dielectric resonator.

17. The antenna structure as claimed in claim 15, wherein a plurality of projection areas of the plurality of grooves vertically projected onto a surface of the transmission layer respectively overlap the plurality of through holes.

18. The antenna structure as claimed in claim 13, wherein the resonator body is cylindrical.

19. The antenna structure as claimed in claim 13, wherein the circuit board is a multilayer structure, the first feed line and the second feed line are respectively located in different layers within the circuit board, and the first feed line and the second feed line are vertically aligned with each other.

20. The antenna structure as claimed in claim 19, wherein the first feed line is located above the second feed line, and a width of the first feed line is smaller than a width of the second feed line.
